(19) United States
(12) Patent Application Publication
(10) Pub. No.: US 2002/0153095 A1
(43) Pub. Date: Oct. 24, 2002

(54) Method for adhesively joining two elements without inclusion of gases

(75) Inventors: Ralf Adelhelm, Kirchhain (DE); Brigitte Hoesselbarth, Grosskarolinenfeld (DE); Hans Kahlfuss, Taufkirchen (DE); Gunter Kuchler, Haselau (DE); Rolf Schwartz, Munchen (DE); Burghardt Wodke, Munchen (DE)

Correspondence Address: Ladas & Parry, 26 West 61 Street, New York, NY, 10023, US

(73) Assignee: ASTRIM GMBH EARTH OBSERVATION & SCIENCE DIV. N/

(21) Appl. No.: 10/120,886

(22) Filed: Apr. 11, 2002

(30) Foreign Application Priority Data
Apr. 11, 2001 (DE) 101 18 228.7

(51) Int. Cl. B29C 65/00

(52) U.S. Cl. 156/312; 156/286

(57) ABSTRACT

A method of adhesively joining two elements by an adhesive layer without gas inclusion in the adhesive layer, wherein an adhesive layer is applied over an area of a surface of a first of the two elements and channels are provided in the adhesive layer for passage of gases therein. An opening around the area of the adhesive layer is in communication with the channels to form a gas escape system so that when the elements are joined together the gases can escape from the adhesive layer via the channels and the opening.

### BACKGROUND OF THE INVENTION

The present invention relates to a method for adhesively joining at least two elements together in which the first element has a surface that is at least partially complementary to a second element and whereas an adhesive is applied at least to a portion of the surface of at least one of the two elements prior to the adhesive joinder. Thus, for example, two or more planar elements can be adhered together or, also, for example, a convexly curved element can be adhered to a corresponding concavely curved element. It is essential only that the elements have surfaces that are at least partially complementary to one another and in this way, the elements can be contacted to one another in a form-fitting manner in these regions.

The form that is complementary may also be generated, however, only within the framework of the adhering process, if, for example, the first element is flexible and is adhered to the second element under pressure so that the first element is deformed to assume the shape of the second element. If an adhesive is applied to at least a part of these surface regions, the elements can be adhesively joined together in these regions by bringing the elements together, for example, by placing one element on top of the other and, if necessary, pressing the elements together.

Such elements can be provided for any purpose in which adhesive joinder of the elements is necessary. For example, electrical or electronic components can be joined to one another or to corresponding carriers or protective layers.

One problem in the adhesive joinder of such elements is that gas inclusions such as gas bubbles or even complete hollow spaces can form in the adhesive layer between the elements, and these gas inclusions can adversely affect the strength of the adhesive joint and may lead to a disruption of the adhesive joint if an expansion of the enclosed gas occurs, for example, by temperature and/or pressure variations. Such gas inclusions may form, for example, directly when the elements are brought together, for example, if the surfaces of the elements are not completely complementary to one another after they are pressed together. Such inclusions can also be formed, for example, by a degassing of the adhesive after the joinder of the elements by gas formation during hardening of the adhesive or under conditions of higher temperatures or lower ambient pressures, such as, for example, at high altitudes or in vacuum in the case of application in aerospace engineering.

### SUMMARY OF THE INVENTION

An object of the present invention is to provide a method for the adhesive joining of at least two elements, in which gas inclusions are substantially avoided in the adhesive layer between the elements.

This object is achieved by a method comprising applying an adhesive layer over an area of a surface of a first of two elements to be joined together, providing channels in said adhesive layer for passage of gases therein, and providing an opening around the area of the adhesive layer in communication with the channels to form a gas escape system therewith. Thereafter, the surface of the first of the two elements is brought into contact with a complementary surface of a second of the two elements at said adhesive layer to adhesively join the two elements together while permitting gases to escape from the adhesive layer via said channels and said opening thereby preventing inclusion of gases in said adhesive layer.

In the method, the first element has a surface that is complementary to the second element after application of the adhesive layer. This means that the form that is complementary to the other can be produced within the framework of the adhering process itself. Prior to the adhering operation, the adhesive is applied onto at least a part of the surface of the first element, and then adherence of the elements is produced by bringing the elements together. According to the invention, the adhesive layer covers the surface on which it is applied, except for the channels, and the opening which form the gas escape system whereby the channels have open ends at the boundary of the adhesive layer. These channels thus form paths allowing the gases to escape in a simple manner from the adhesive layer region, where the elements are adheringly joined together. The form, number and arrangement of the channels can be adapted according to need, as can the number of open ends for the channels. It is essential only that paths are created, along which gases can escape from the region of the adhesive joinder.

The elements can then be brought together in such a way that the channels become fully or partially filled by the adhesive material. However, sufficient paths for gas escape must remain, at the boundary of the joined region. This is particularly important if, afer adhering the elements, gases can still arise in the adhesive layer as it hardens, which gases will be discharged from the adhesive layer in order to avoid a formation of gas inclusions after the joinder has been produced. However, if this is not critical, the adhesive can be applied and the elements can be brought together such that the channels will be completely filled by the adhesive, for example, by applying a suitable high pressure to the elements.

In order to insure that the channels are not filled by the adhesive before the gas is expelled, the channels widen towards the periphery of the adhesive region. Therefore, even if the channels are partially filled by laterally penetrating adhesive, sufficient paths still remain for escape of gases.

The special course of the channels in the adhesive layer can be adapted to the particular requirement. In the simplest case, the adhesive is applied in such a way that the channels are essentially perpendicular to the edge of the adhesive region. The channels can deviate slightly from straight lines, for example, they can be slightly undulating in shape, but overall, the channel arrangement will extend perpendicular to the edge of the adhesive region. However, the adhesive can also be applied so that the channels form an angle of between 0° and 90° with the edge of the adhesive region.

The adhesive can be applied so that two rows of channels lie opposite one another. In this case, two comb-shaped configurations of the channels and the peripheral opening are formed, in which the “teeth” of the combs lie opposite one another. Thus, an escape of the gases to both sides can be obtained, which assures an improved escape of gases. The adhesive may also be applied such that the two rows of channels of the two comb-like configurations are offset and the “teeth” of the combs can interengage one another. Thus an escape of gases is assured for the adhesive region over as large a region as possible.

Finally, the adhesive can be applied in such a way that the channels have rounded contours at the ends where they join with the peripheral opening. The rounded contours can also be provided at the closed ends of the channels inside the adhesive region. A penetration of the adhesive into the channels when the elements are brought together is avoided, even at specific pressures, by such rounded contours, so that the gas escape function is assured after the elements have been brought together.

### BRIEF DESCRIPTION OF THE FIGURES OF THE DRAWING

FIG. 1 is a top view of an element on which an adhesive layer has been deposited.

FIG. 1A is a sectional view of a portion of two adhesively joined elements.

FIG. 2 is similar to FIG. 1, but shows another shape of the element.

FIG. 3 is similar to FIG. 1, but with a modified adhesive layer.

FIG. 4 is similar to FIG. 3 but with a different shape of the element.

### DETAILED DESCRIPTION

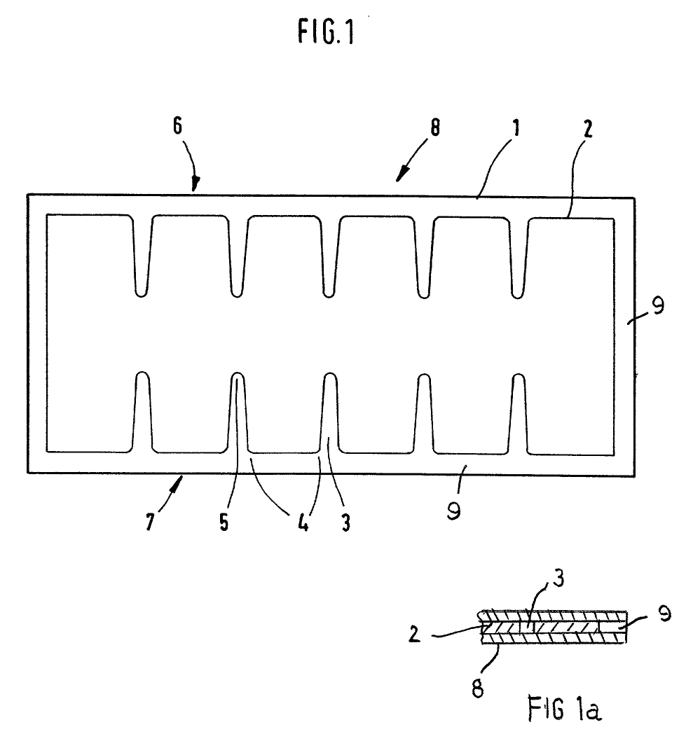

FIGS. 1 to 4, illustrate adhesive layers for the adhesive joinder of different elements of electrical or electronic structures, particularly, solar cells or solar generators. The method according to the invention is applicable, for example, for adhesively joining solar cells to a carrier or for applying glass covers or similar transparent protective layers on solar cells or to arrange different solar cell layers above one another.

For this purpose, an adhesive 2 is applied onto an area or region 1 of a first element 8 such that channels 3 are left free in the adhesive layer. Element 8, can be, for example, a solar cell, which is intended to be adhesively joined with another element 10 for example, a carrier for the solar cell. The solar cell or first element 2 and the carrier or second element 10 have planar surfaces along which they are joined. Alternatively, at least one of the elements is flexible so that it can be pressed against the corresponding surface of the other element so that the surface of the flexible element can adapt itself to the form of the other surface, for example, a planar form.

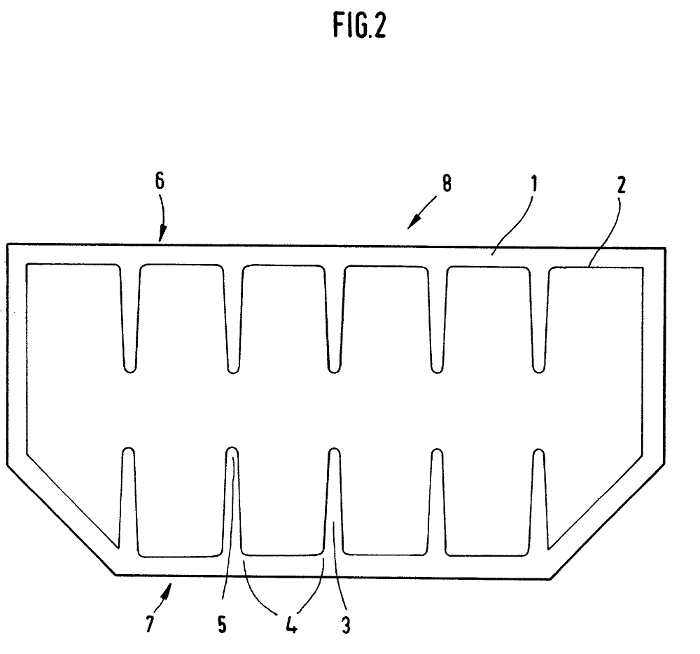

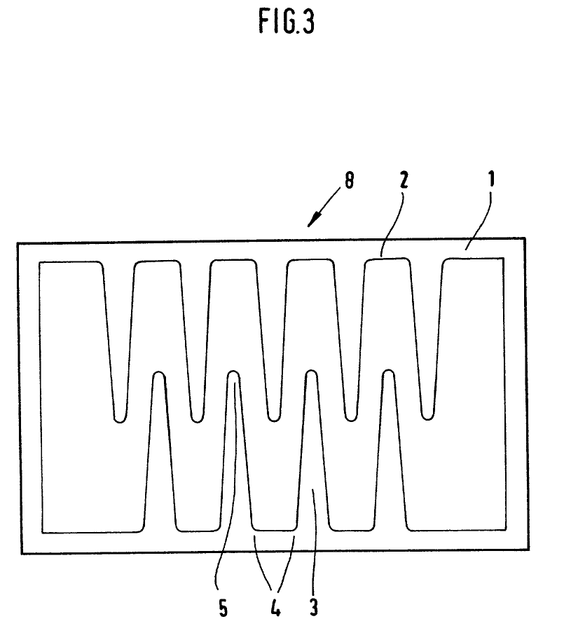

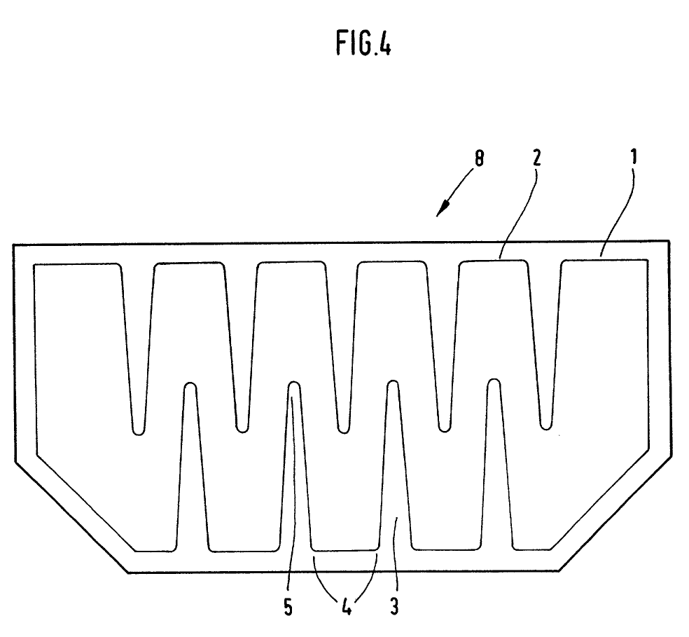

In FIGS. 1 to 4, channels 3 extend substantially perpendicular to the edges 6, 7 of the surface 1. Channels 3 extend from the interior of the adhesive layer 2 to a peripheral opening 9 at the edges 6, 7 of surface 1. The channels 3 are in communication with the opening 9 to form a gas escape system which permits gases to escape from the adhesive layer to prevent inclusion of gases in the adhesive layer. The embodiments of FIGS. 2 and 4 correspond to those in FIGS. 1 and 3 except that element 8 has a somewhat different form. In FIGS. 2 and 4, the adhesive layer 2 is adapted to the shape of surface 1 so that the opening 9 around the adhesive region 2 follows the shape of the edges of the element 8 and suitable boundary edges 6, 7 are selected, from which channels 3 extend. The method can be conducted analogously with any shape of element 8. Each channel 3 is widened at its open end, and thus has the form of a V. In this way, it can be prevented that channels 3 will be filled by laterally penetrating adhesive when the two elements are brought together under pressure, as long as the pressure is not too great. Therefore, channels 3 will still remain open after adherence of the elements and permit discharge of gases that develop by degassing of the adhesive from the adhesive layer 2.

In the embodiments of FIGS. 1 and 2, the channels 3 are arranged opposite one another, so that two opposing comb-shaped configurations are formed. In addition, the open ends of channels 3 are rounded at 4 and the closed ends of the channels are rounded at 5. The rounded contours at 4 and 5 also prevent adhesive from penetrating laterally into the channels right at these sites, thereby sealing the channels, when the two elements are brought together under pressure. This is particularly important at the open ends of channels 3, since otherwise, channels 3 themselves would become hollow spaces in adhesive layer 2, and thus could no longer assure escape of gases, but rather could damage the adhesive layer 2.

The embodiments of FIGS. 3 and 4 have all of the features of the embodiments of FIGS. 1 and 2, especially the rounded contours 4 and 5 as well as the widening of channels 3, but herein, the channels 3 of the comb-shaped configurations are laterally displaced relative to one another so that the channels 3 of the comb-shaped configurations extend past one another. The comb-shape configurations thus partially overlap one another and in this way, an escape of gases can be assured over as large a region as possible of adhesive layer 2, so that the danger of the formation of gas inclusions can be kept as small as possible. This is particularly important if the primary object is not that the adhesive layer cover the surface as much as possible but that gas inclusion must be prevented to as high a degree as possible.

Although the invention is disclosed with reference to particular embodiments thereof, it will become apparent to those skilled in the art that numerous modifications and variations can be made which will fall within the scope and spirit of the invention as defined by the attached claims.

1. A method of adhesively joining two elements by an adhesive layer without gas inclusion in the adhesive layer, said method comprising:
applying an adhesive layer over an area of a surface of a first of two elements to be joined together,
providing channels in said adhesive layer for passage of gases therein,
providing an opening around said area of said adhesive layer in communication with said channels to form a gas escape system therewith, and
contacting the surface of the first of the two elements with a complementary surface of a second of the two elements at said adhesive layer to adhesively join the two elements together while permitting gases to escape from the adhesive layer via said channels and said opening thereby preventing inclusion of gases in said adhesive layer.

2. The method of claim 1 wherein said opening extends to an edge of said first element and said channels extend inwardly from said opening.

3. The method of claim 2, wherein said channels extend in spaced relation from one another perpendicularly to said opening to form a comb shape therewith.

4. The method of claim 3, wherein said opening extends along opposite edges of said first element and said channels form two comb shaped configurations of said channels and said opening.

5. The method of claim 4, wherein the channels of the two comb-shaped configurations are aligned with one another.

6. The method of claim 4, wherein the channels of the two comb-shaped configurations are laterally offset from one another.

7. The method of claim 6, wherein the channels in the two comb-shaped configurations extend past one another.

8. The method of claim 4, wherein said elements are pre-formed with complementary surfaces.

9. The method of claim 4, wherein said surfaces of said two elements are pressed together to conform with one another and provide said complementary surfaces.

10. The method of claim 2, wherein said channels extend in spaced relation from one another, at least some of said channels extending perpendicular to said opening while others of said channels extend at an angle with respect to said opening.

11. The method of claim 1, wherein said channels are formed so that the channels widen towards said opening.

12. The method of claim 1, wherein said channels extend in spaced relation from one another at an angle of between 0° and 90° with respect to said opening.

13. The method of claim 1, wherein said channels are formed in said adhesive layer in two rows facing one another.

14. The method of claim 1, wherein said channels are rounded where they join said opening.

15. The method of claim 1, wherein when said elements are brought into contact with one another, said passages are at least partially filled with the adhesive.

16. The method of claim 15, wherein said passages become completely filled with adhesive when the elements are joined together while said opening remains open.

17. The method of claim 1, wherein one of said elements is formed as a part of a solar cell.

18. The method of claim 17, wherein the other said element is a carrier for the solar cell part.

19. The method of claim 17, wherein the other said element is a transparent covering for the solar cell part.

20. A method of adhesively joining two elements by an adhesive layer without gas inclusion in the adhesive layer, said method comprising:
applying an adhesive layer over an area of a surface of one element to be joined to a complementary surface of a second element, and
forming a gas passage means in said adhesive layer for escape of gases from the adhesive layer when bringing said surfaces of the two elements into contact with one another whereby to prevent gas inclusion in said adhesive layer after joining the two elements together.

21. The method of claim 20, wherein said gas passage means is formed by providing gas passages in said adhesive layer which extend throughout said layer and exit outwardly thereof.
